(19) United States
(12) Patent Application Publication
(10) Pub. No.: US 2019/0045474 A1
(43) Pub. Date: Feb. 7, 2019

(54) METHODS AND APPARATUSES FOR CONTROLLING VEHICLE-TO-VEHICLE INTERFERENCE

(71) Applicant: Nokia Technologies Oy, Espoo (FI)

(72) Inventors: Zexian Li, Espoo (FI); Cassio Ribeiro, Espoo (FI); Ling Yu, Kauniainen (FI); Jari Lindholm, Palojoki (FI); Juha Korhonen, Espoo (FI)

(21) Appl. No.: 16/074,573

(22) PCT Filed: Feb. 3, 2017
(86) PCT No.: PCT/IB2017/050580

§ 371 Date: Aug. 1, 2018

Related U.S. Application Data
(60) Provisional application No. 62/291,928, filed on Feb. 5, 2016.

(51) Int. Cl. H04W 56/00; H04W 24/10

(52) U.S. Cl. CPC H04W 56/0065; H04W 84/06; H04W 24/10

(57) ABSTRACT

Systems, methods, apparatuses, and computer program products for controlling vehicle-to-vehicle (V2V) interference are provided. One method may include receiving, by a base station, timing information from a user equipment, and determining a timing difference between network timing at the base station and at least one of global navigation satellite system (GNSS) timing at the base station or the received timing information. The received timing information comprises at least one of a global navigation satellite system (GNSS) timing at the user equipment or a timing difference calculated based on a network timing at the user equipment and the global navigation satellite system (GNSS) timing at the user equipment.

### CROSS-REFERENCE TO RELATED APPLICATIONS

This application claims priority from U.S. Provisional Application No. 62/291,928, filed on Feb. 5, 2016. The entire contents of this earlier filed application are hereby incorporated by reference in their entirety.

### BACKGROUND

### Field

Embodiments of the invention generally relate to wireless or mobile communications networks, such as, but not limited to, the Universal Mobile Telecommunications System (UMTS) Terrestrial Radio Access Network (UTRAN), Long Term Evolution (LTE) Evolved UTRAN (E-UTRAN), LTE-Advanced (LTE-A), LTE-Advanced Pro, future 5G radio access technology, and/or High Speed Packet Access (HSPA). In particular, some embodiments may relate to vehicular communications, such as communications between a vehicle and another vehicle, between a vehicle and the network, and/or between a vehicle and other parties.

### Description of the Related Art

Universal Mobile Telecommunications System (UMTS) Terrestrial Radio Access Network (UTRAN) refers to a communications network including base stations, or Node Bs, and for example radio network controllers (RNC). UTRAN allows for connectivity between the user equipment (UE) and the core network. The RNC provides control functionalities for one or more Node Bs. The RNC and its corresponding Node Bs are called the Radio Network Subsystem (RNS). In case of E-UTRAN (enhanced UTRAN), no RNC exists and radio access functionality is provided in the evolved Node B (eNodeB or eNB) or many eNBs. Multiple eNBs are involved for a single UE connection, for example, in case of Coordinated Multipoint Transmission (CoMP) and in dual connectivity.

Long Term Evolution (LTE) or E-UTRAN provides a new radio access technology and refers to the improvements of UMTS through improved efficiency and services, lower costs, and use of new spectrum opportunities. In particular, LTE is a 3GPP standard that provides for uplink peak rates of at least, for example, 75 megabits per second (Mbps) per carrier and downlink peak rates of at least, for example, 300 Mbps per carrier. LTE supports scalable carrier bandwidths from 20 MHz down to 1.4 MHz and supports both Frequency Division Duplexing (FDD) and Time Division Duplexing (TDD).

As mentioned above, LTE may also improve spectral efficiency in networks, allowing carriers to provide more data and voice services over a given bandwidth. Therefore, LTE is designed to fulfill the needs for high-speed data and media transport in addition to high-capacity voice support. Advantages of LTE include, for example, high throughput, low latency, FDD and TDD support in the same platform, an improved end-user experience, and a simple architecture resulting in low operating costs.

Certain releases of 3GPP LTE (e.g., LTE Rel-10, LTE Rel-11, LTE Rel-12, LTE Rel-13) are targeted towards international mobile telecommunications advanced (IMT-A) systems, referred to herein for convenience simply as LTE-Advanced (LTE-A).

LTE-A is directed toward extending and optimizing the 3GPP LTE radio access technologies. A goal of LTE-A is to provide significantly enhanced services by means of higher data rates and lower latency with reduced cost. LTE-A is a more optimized radio system fulfilling the international telecommunication union-radio (ITU-R) requirements for IMT-Advanced while keeping the backward compatibility.

5G is the new generation of radio systems and network architecture delivering extreme broadband and ultra-robust, low latency connectivity and massive networking for the Internet of Things (IoT) to enable the programmable world, which can transform individual lives, the economy and society as a whole.

### SUMMARY

One embodiment is directed to a method, which may include receiving, by a base station, timing information from a user equipment, and determining a timing difference between network timing at the base station and at least one of global navigation satellite system (GNSS) timing at the base station or the received timing information. The received timing information comprises at least one of a global navigation satellite system (GNSS) timing at the user equipment or a timing difference calculated based on a network timing at the user equipment and the global navigation satellite system (GNSS) timing at the user equipment.

Another embodiment is directed to an apparatus including at least one processor and at least one memory including computer program code. The at least one memory and the computer program code are configured, with the at least one processor, to cause the apparatus at least to receive timing information from a user equipment, and determine a timing difference between network timing at the apparatus and at least one of global navigation satellite system (GNSS) timing at the apparatus or the received timing information. The received timing information comprises at least one of a global navigation satellite system (GNSS) timing at the user equipment or a timing difference calculated based on a network timing at the user equipment and the global navigation satellite system (GNSS) timing at the user equipment.

Another embodiment is directed to an apparatus including means for receiving timing information from a user equipment, and means for determining a timing difference between network timing at the apparatus and at least one of global navigation satellite system (GNSS) timing at the base station or the received timing information. The received timing information comprises at least one of a global navigation satellite system (GNSS) timing at the user equipment or a timing difference calculated based on a network timing at the user equipment and the global navigation satellite system (GNSS) timing at the user equipment.

Another embodiment is directed to an a method, which may include receiving, at an in-coverage vehicle user equipment, timing information from a network node, and forwarding the timing information to out of coverage vehicle user equipment.

Another embodiment is directed to an apparatus including at least one processor and at least one memory including computer program code. The at least one memory and the computer program code are configured, with the at least one processor, to cause the apparatus at least to receive timing information from a network node, and forward the timing information to out of coverage vehicle user equipment.

Another embodiment is directed to an apparatus including receiving means for receiving timing information from a network node, and transmitting means for forwarding the timing information to out of coverage vehicle user equipment.

Another embodiment is directed to a method, which may include sending, by a user equipment, timing information to a base station. The timing information may include at least one of a global navigation satellite system (GNSS) timing at the user equipment or a timing difference calculated based on a network timing at the user equipment and the global navigation satellite system (GNSS) timing at the user equipment.

Another embodiment is directed to an apparatus, which may include at least one processor and at least one memory including computer program code. The at least one memory and the computer program code are configured, with the at least one processor, to cause the apparatus at least to send timing information to a base station. The timing information may include at least one of a global navigation satellite system (GNSS) timing at the apparatus or a timing difference calculated based on a network timing at the apparatus and the global navigation satellite system (GNSS) timing at the apparatus.

Another embodiment is directed to an apparatus, which may include means for sending timing information to a base station. The timing information may include at least one of a global navigation satellite system (GNSS) timing at the apparatus or a timing difference calculated based on a network timing at the apparatus and the global navigation satellite system (GNSS) timing at the apparatus.

### BRIEF DESCRIPTION OF THE DRAWINGS

For proper understanding of the invention, reference should be made to the accompanying drawings, wherein:

FIG. 1 illustrates an example of a system according to one embodiment;

FIG. 2 illustrates a flow diagram of a method, according to one embodiment;

FIG. 3 illustrates a flow diagram of a method, according to another embodiment;

FIG. 4 illustrates an example of the timing difference derivation, according to one embodiment;

FIG. 5a illustrates an example block diagram of an apparatus, according to one embodiment; and

FIG. 5b illustrates an example block diagram of an apparatus, according to another embodiment;

### DETAILED DESCRIPTION

It will be readily understood that the components of the invention, as generally described and illustrated in the figures herein, may be arranged and designed in a wide variety of different configurations. Thus, the following detailed description of embodiments of systems, methods, apparatuses, and computer program products for vehicular communications, as represented in the attached figures, is not intended to limit the scope of the invention, but is merely representative of some selected embodiments of the invention.

The features, structures, or characteristics of the invention described throughout this specification may be combined in any suitable manner in one or more embodiments. For example, the usage of the phrases “certain embodiments,” “some embodiments,” or other similar language, throughout this specification refers to the fact that a particular feature, structure, or characteristic described in connection with the embodiment may be included in at least one embodiment of the present invention. Thus, appearances of the phrases “in certain embodiments,” “in some embodiments,” “in other embodiments,” or other similar language, throughout this specification do not necessarily all refer to the same group of embodiments, and the described features, structures, or characteristics may be combined in any suitable manner in one or more embodiments.

Additionally, if desired, the different functions discussed below may be performed in a different order and/or concurrently with each other. Furthermore, if desired, one or more of the described functions may be optional or may be combined. As such, the following description should be considered as merely illustrative of the principles, teachings and embodiments of this invention, and not in limitation thereof.

Certain embodiments of the invention relate to LTE Rel-14 vehicle-to-vehicle (V2V) work item (WI) and Rel-13 V2X study item (SI). It is predicted that vehicles in the future will communicate with each other in order to improve awareness and security. The term V2X refers to vehicular communications, where the X can be another vehicle, the network, infrastructure (e.g., roads, buildings, traffic lights, etc.), or others (e.g., pedestrians, bikes, etc.). V2X that may be supported by radio systems is now receiving much attention. For example, within cellular networks, V2X will likely be one of the drivers of future 4G releases (V2V WI and V2I/V2P SI ongoing in 3GPP) and 5G systems (e.g., EU FP7 METIS project).

Within V2V, the principle of cooperative awareness applications is that each vehicle broadcasts information about itself, such as location, speed, traveling direction, among other information, enabling vehicles to be mutually aware of their presence and warn the driver when imminent danger is detected. For this purpose, the European Telecommunications Standards Institute (ETSI) has standardized the Cooperative Awareness Message (CAM).

Taking LTE Rel-12 proximity services (ProSe) specification as the starting point, 3GPP has been working on extending the specified ProSe to V2X usage. In 2015, a main focus in 3GPP RAN1 was on V2V and the outcome of the SI is included in 3GPP TR 36.885. V2V communication should be supported both on carriers dedicated for V2V (or V2X) and by sharing a cellular carrier. Certain embodiments of the invention are directed to the handling of interference from out of coverage (OOC) vehicle UEs (VUEs) to cellular operation.

A vehicle UE may be under network coverage or not under coverage. Both coverage scenarios should be supported and studied in 3GPP. During the study item phase, RAN1 has agreed that global navigation satellite system (GNSS) or GNSS-equivalent is at the highest priority of synchronization source for time and frequency when the vehicle UE directly receives GNSS or GNSS-equivalent with sufficient reliability and the UE does not detect any cell in any carrier. RAN1 further agreed that the eNB instructs vehicle UE to prioritize either eNB-based synchronization or GNSS or GNSS-equivalent at least when the eNB is in the carrier where the vehicle UE operates on PC5 V2V.

Further, RAN1 assumes that eNBs may not always have GNSS or GNSS-equivalent. With these agreements and assumptions, it should be noted that for OOC VUEs, if available the highest priority is GNSS or GNSS-equivalent, which is different from the Rel-12/13 ProSe synchronization. In the Rel-12/13 synchronization information from the network can be further relayed by in-coverage UE to OOC UE, and in case the synchronization signal from in coverage UE is available, it has higher priority than the synchronization signal from OOC UEs. In this way, the OOC UEs that are close to the coverage border still use cellular synchronization as their synchronization source and hence the potential interference from OOC UE can be reduced.

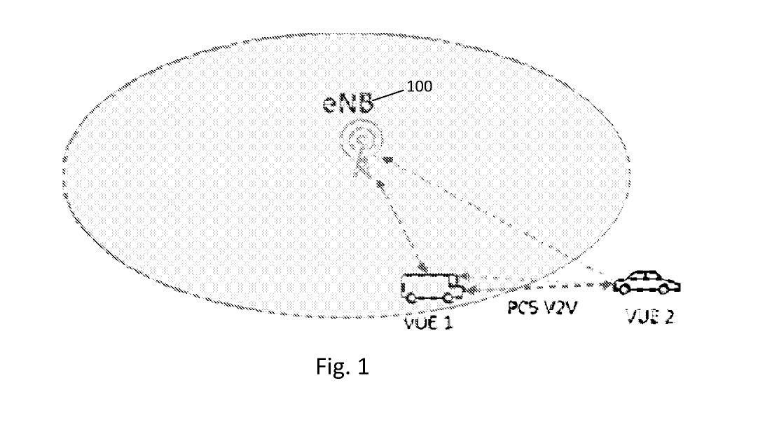

However, according to the current assumptions of V2V operation, due to the introduction of high priority of GNSS or GNSS-equivalent, synchronization for transmission does not propagate from in-coverage VUEs to OOC VUEs. In-coverage VUEs may transmit a sidelink synchronization signal (SLSS), but OOC VUEs with GNSS do not synchronize their transmissions on the SLSS. Rather, in this situation, SLSS is utilized just for the reception of the in-coverage VUEs broadcast. In the case where the network is not synchronized to GNSS and in coverage UEs are not requested to prioritize GNSS or GNSS equivalent, in coverage UEs and OOC UEs will follow different synchronization timing. Serious interference can take place, as illustrated in the example of FIG. 1. The system in the example of FIG. 1 includes at least one eNB 100 and vehicular UEs, VUE 1 and VUE 2. In FIG. 1, an example interference scenario from OOC VUEs is depicted. As illustrated in FIG. 1, the dotted lines indicate possible interference from OOC VUEs to either eNB reception or VUE reception. This may be particularly problematic in the case of a TDD network where V2V transmission can interfere with downlink (DL) reception as well.

Different options may be applied to solve the above-described problem. A first option is to synchronize the network to GNSS (at least on the carrier operating PC-5 based V2V). This might bring significant impacts to legacy deployments where GNSS has not been used, and hence cost and required efforts can be a serious issue. A second option is to apply a similar synchronization framework as Rel-12/13 ProSe where the in-coverage UE synchronization source always has higher priority and OOC VUEs must search possible in-coverage UEs all the time. With this option, the benefits of using GNSS for synchronization are lost to a large extent.

A third option is to further enhance the current scheme by reducing the possible interference in case of mismatched synchronization references. Embodiments of the invention are focused on this third option and provides further enhancement to reduce potential interference from OOC VUEs.

Although OOC UEs cannot detect any cells, they can detect in-coverage UEs (based on synchronization signal transmitted by in coverage UEs in a similar way as in Rel-12) and vice versa, as illustrated in FIG. 1. Embodiments of the invention address different ways to minimize the potential interference.

According to an embodiment, in the case where the eNB does not have GNSS or GNSS-equivalent available, the eNB may request a vehicle UE at cell edge, for example a vehicle with reference signal received power (RSRP) being less than a preset or predefined threshold, to report to the eNB the detected OOC vehicle UEs. The eNB may utilize this information for optimizing scheduling of cellular transmissions. In one form, the optimization might mean that the vehicle UEs reporting none or only infrequent detections of OOC vehicle UEs may be scheduled to the carrier or radio resource shared by cellular and V2V communications, while vehicle UEs that report frequent detection of OCC vehicle UEs may be scheduled on a cellular carrier or radio resource that is not shared with V2V communications.

In another embodiment, instead of the eNB requesting in coverage VUEs to report the detection result of possible presence of OOC VUE, the in coverage UE may always search OOC VUEs, for example by checking the SLSS transmitted by OOC VUEs. Once an OOC VUE is detected, the in coverage VUE may send a report to eNB.

In certain embodiments, the scheduling may be optimized also within a shared carrier if the reporting includes at least rough information on the GNSS timing (ways to obtain such information are discussed below). Since the eNB is aware of the preconfigured resource pool(s) for OOC vehicle UEs, the eNB may try to optimize the scheduling process by allocating resources to UEs who cannot detect OOC vehicle UEs. In this way, the interference from OOC vehicle UEs to cellular reception can be avoided. Similarly, possible interference at eNB reception can be reduced as well if the eNB has certain knowledge of where the OOC VUEs are located. Those non-vehicle UEs that cannot be requested to report on V2V transmissions may be treated, from the scheduling point of view, similarly as vehicle UEs reporting frequent OOC vehicle UE detections. Non-vehicle UEs may also report the presence of OOC vehicle UEs.

In another embodiment, OOC vehicle UEs may adapt according to their detections. For example, when an OOC vehicle UE can detect in-coverage vehicle UE, the transmission power may be reduced to minimize the interference to cellular reception. In order to keep the same coverage, more repetition may be applied or other ways may be used to compensate for the reduced coverage due to reduced transmit (Tx) power. This approach may be used to protect cellular UEs against interference from OOC vehicular UEs as well.

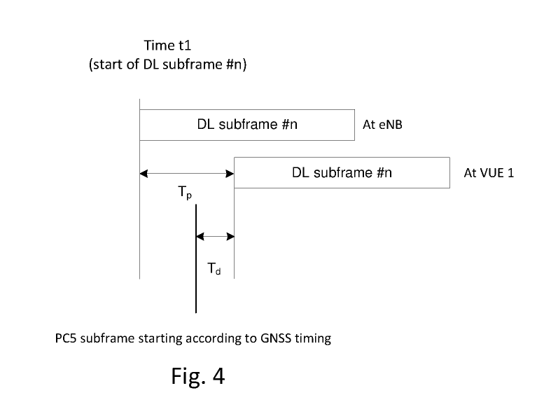

According to an embodiment, the eNB can determine the rough timing difference between its own clock and GNSS or GNSS-equivalent based on the timing information reported by a vehicle UE and the corresponding timing advance (TA) value. Another option is for the VUE to report T_{d} or TA/2−T_{d} (the difference between cellular timing and GNSS timing as illustrated in FIG. 4) to the eNB. The trigger for in coverage VUEs to report T_{d} or TA/2−T_{d} can be (1) first time detecting OOC VUE, or (2) the previous value is not valid any more, or (3) requested by the eNB, or a combination or at least two of the three. Periodical or aperiodical reporting is possible.

In one embodiment, in order to reduce the potential collision usage of resource pools, after the eNB obtains knowledge of the presence of OOC VUEs, the eNB may request in-coverage VUEs to deliver the resource usage recommendation information to OOC VUEs. For example, the eNB may recommend the OOC VUEs to use a certain part of the pre-configured resources, and the remaining part of the pre-configured resource may be used by in-coverage VUEs for V2V or cellular communication. The recommendation may be applied only by OOC VUEs that receive the recommendation directly from an in-coverage UE, or, in some other embodiments, the OOC VUEs are requested to forward the recommendation to the OOC VUEs that are not able to receive the recommendation directly from any in-coverage UE so that those OOC VUEs can take the recommendation into account in their V2V communication. For example, the OOC VUEs that receives the recommendation from other OOC VUEs may determine to use the recommended resource or not depending on the collision rate detected on the recommended resource.

According to an embodiment, when in-coverage VUEs can forward network timing information to out-of-coverage UEs, it may indicate whether out-of-coverage UEs should utilize GNSS timing, or else synchronize to timing indicated by in-coverage VUE.

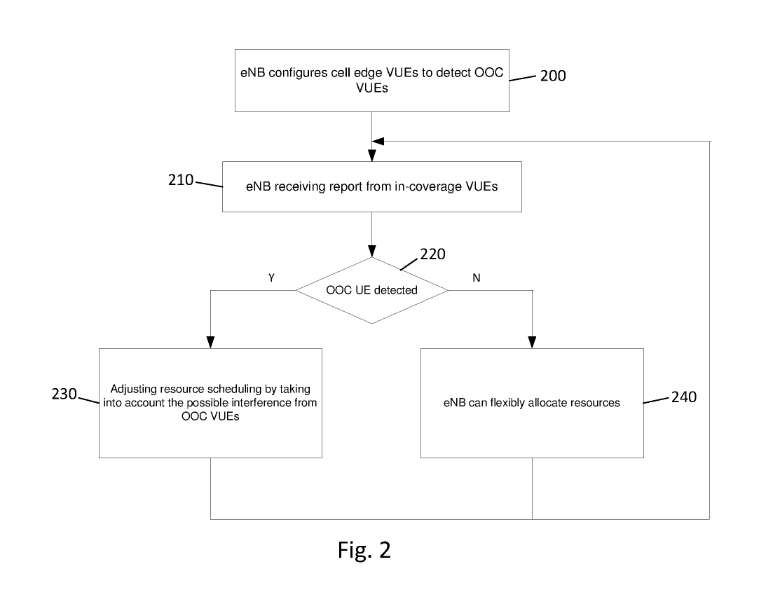

FIG. 2 illustrates an example of a process that may be performed at the eNB, according to one embodiment of the invention. As illustrated in FIG. 2, at 200, the eNB may configure cell/coverage edge VUEs to detect OOC VUEs. At 210, the eNB may receive report(s) from in-coverage VUEs. Depending on the received report from configured VUEs, in case there is OOC VUEs detected at 220, the eNB may take the detected OOC VUEs into account during the scheduling process. For example, referring again to the system illustrated in FIG. 1, VUE 1 may report back to eNB 100 about the existence of OOC VUE 2. If there are OOC UEs detected, at 230, the eNB may adjust resource scheduling by taking into account the possible interference from OOC VUEs. If there are no OOC UE detected, at 240, the eNB may flexibly allocate resources.

Thus, with the help of knowledge of pre-configured resource pool information for OOC operation and the rough estimation of timing, for example, the timing or timing information derived based on the feedback from in-coverage VUE and its TA value, the eNB can avoid allocated resource(s) within OOC resource pool to VUE1. How to derive the time difference between GNSS or GNSS equivalent and the cellular timing will be discussed below after looking at the OOC VUE behaviour.

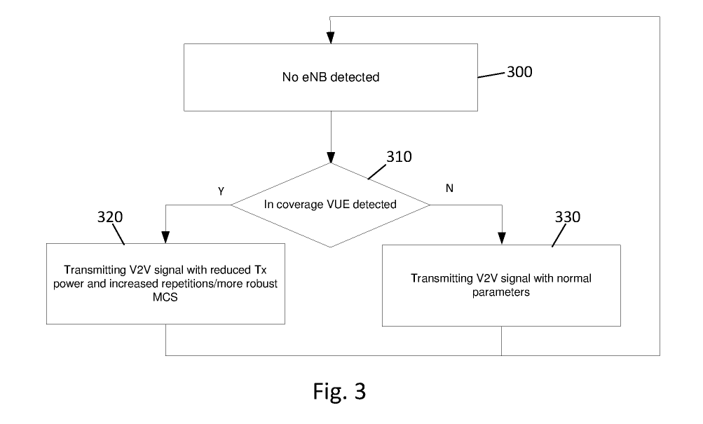

FIG. 3 illustrates an example of a process that may be performed by a VUE, such as an OOC VUE, according to one embodiment of the invention. As illustrated in FIG. 3, at 300, the VUE may detect that no eNB is available. At 310, the VUE determines whether any in-coverage VUE(s) are detected. If in-coverage VUE(s) are detected, at 320, the VUE may transmit a V2V signal with reduced transmit power, or also with increased repetitions of transmissions, or further with more robust modulation and coding scheme (MCS). If no in-coverage VUE(s) are detected, the VUE may transmit a V2V signal with normal parameters.

Therefore, depending on whether in-coverage VUEs detected or not, different procedures can be applied to OOC VUEs when selecting suitable transmission parameters.

One issue mentioned above is how to derive the time difference between the eNB clock and GNSS or GNSS-equivalent. When a VUE has GNSS or GNSS-equivalent available (when the signals are available), the VUE assisted timing difference derivation is provided as illustrated in the example of FIG. 4. As illustrated in FIG. 4, Tₚ is the propagation delay, whose value can be equal to half of TA value, and T_{d} is the time difference between GNSS and eNB timing at VUE1.

According to an embodiment, when a UE reports T_{d} to the eNB, the eNB can derive the timing difference between its own clock and GNSS based timing (i.e., Tₚ−T_{d}=TA/2−T_{d}). In another embodiment, instead of T_{d}, the UE may also report TA/2−T_{d} value to the eNB. A benefit of this approach is that the eNB does not have to remember all the TA commands that it has sent to the VUE and autonomous TA changes made by the VUE are also taken into account as well as missed TA commands. With the timing difference information and the pre-configured resource information, the eNB can know the overlapping resource with OOC VUEs. As the eNB is aware of VUE's exact TA value only immediately after random access procedure, the reporting may also include the TA value.

As discussed above, after in-coverage VUEs reporting T_{d} and the presence of OOC VUEs, the eNB may obtain the information of the resource used by OOC VUEs. With such information, a further optimization step may be that, depending on the resource occupation within the pre-configured resources for OOC VUEs, the eNB may send recommendation information to OOC VUEs via in-coverage VUEs. The recommended resource is a subset of the whole pre-configured resources. For example, recommendation information may be that OOC VUEs can only transmit in certain time slots and/or certain physical resource blocks (PRBs). In this way, the rest of the pre-configured resource may be used by in-coverage VUEs. This recommendation based approach resembles the procedure in FIG. 3: VUE receiving a recommendation corresponds to detection in 310, and, corresponding to 320, the UE adapts its transmissions according to the recommendation.

In another implementation example, when in-coverage VUEs can forward network timing information to out-of-coverage UEs as specified in LTE REL-12/13 ProSe, on top of the specified function, one further optimization step may be that the in-coverage VUEs indicate whether out-of-coverage VUEs should utilize GNSS timing or synchronize to timing indicated by the in-coverage VUE.

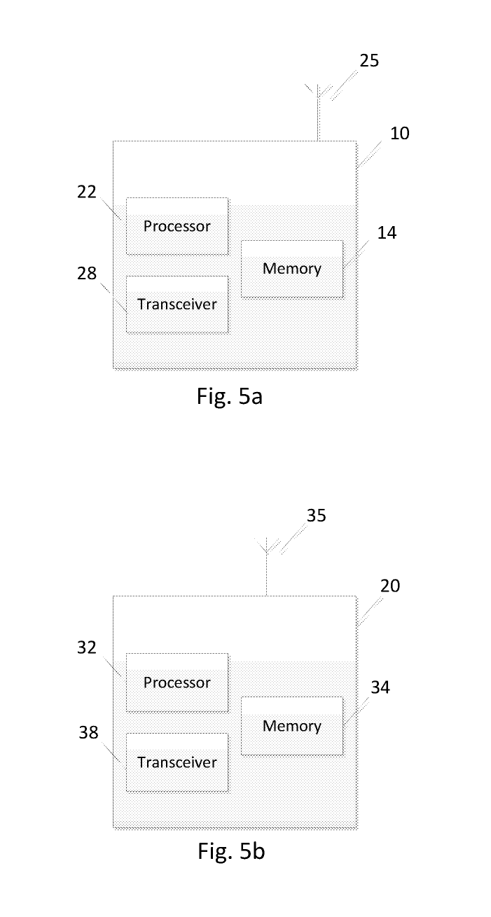

FIG. 5a illustrates an example of an apparatus 10 according to an embodiment. In an embodiment, apparatus 10 may be a node, host, or server in a communications network or serving such a network. For example, in certain embodiments, apparatus 10 may be a network access node or network entity for a radio access network, such as LTE or LTE-A. Thus, in certain embodiments, apparatus 10 may be a base station or eNB. However, in other embodiments, apparatus 10 may be other components within a radio access network. It should be noted that one of ordinary skill in the art would understand that apparatus 10 may include components or features not shown in FIG. 5a.

As illustrated in FIG. 5a, apparatus 10 includes a processor 22 for processing information and executing instructions or operations. Processor 22 may be any type of general or specific purpose processor. While a single processor 22 is shown in FIG. 5a, multiple processors may be utilized according to other embodiments. In fact, processor 22 may include one or more of general-purpose computers, special purpose computers, microprocessors, digital signal processors (DSPs), field-programmable gate arrays (FPGAs), application-specific integrated circuits (ASICs), and processors based on a multi-core processor architecture, as examples.

Apparatus 10 may further include or be coupled to a memory 14 (internal or external), which may be coupled to processor 22, for storing information and instructions that may be executed by processor 22. Memory 14 may be one or more memories and of any type suitable to the local application environment, and may be implemented using any suitable volatile or nonvolatile data storage technology such as a semiconductor-based memory device, a magnetic memory device and system, an optical memory device and system, fixed memory, and removable memory. For example, memory 14 can be comprised of any combination of random access memory (RAM), read only memory (ROM), static storage such as a magnetic or optical disk, or any other type of non-transitory machine or computer readable media. The instructions stored in memory 14 may include program instructions or computer program code that, when executed by processor 22, enable the apparatus 10 to perform tasks as described herein.

In some embodiments, apparatus 10 may also include or be coupled to one or more antennas 25 for transmitting and receiving signals and/or data to and from apparatus 10. Apparatus 10 may further include or be coupled to a transceiver 28 configured to transmit and receive information. For instance, transceiver 28 may be configured to modulate information on to a carrier waveform for transmission by the antenna(s) 25 and demodulate information received via the antenna(s) 25 for further processing by other elements of apparatus 10. In other embodiments, transceiver 28 may be capable of transmitting and receiving signals or data directly.

Processor 22 may perform functions associated with the operation of apparatus 10 which may include, for example, precoding of antenna gain/phase parameters, encoding and decoding of individual bits forming a communication message, formatting of information, and overall control of the apparatus 10, including processes related to management of communication resources.

In an embodiment, memory 14 may store software modules that provide functionality when executed by processor 22. The modules may include, for example, an operating system that provides operating system functionality for apparatus 10. The memory may also store one or more functional modules, such as an application or program, to provide additional functionality for apparatus 10. The components of apparatus 10 may be implemented in hardware, or as any suitable combination of hardware and software.

In one embodiment, apparatus 10 may be a network node or network entity, such as a base station or eNB, for example. According to certain embodiments, apparatus 10 may be controlled by memory 14 and processor 22 to configure one or more VUE(s) at cell edge to detect and/or report OOC VUE(s). Apparatus 10 may then be controlled by memory 14 and processor 22 to receive a report from the configured VUE(s); the report may include, for example, information on whether any OOC VUE(s) are detected. In an embodiment, apparatus 10 may also be controlled by memory 14 and processor 22 to adjust or optimize resource scheduling by taking into account possible interference from any detected OOC VUE(s).

For example, apparatus 10 may be controlled to utilize information included in the report for optimizing scheduling of cellular transmissions. In one embodiment, when the received report indicates that the VUE(s) do not detect any OOC VUE(s) or only infrequently detect OOC VUE(s), apparatus 10 may be controlled to optimize resource scheduling by scheduling the VUE(s) on a carrier shared by cellular and V2V communications. In another embodiment, when the received report indicates that the VUE(s) are detecting OCC VUE(s), apparatus 10 may be controlled to optimize resource scheduling by scheduling the VUE(s) on a cellular carrier that is not shared with V2V communication.

According to one embodiment, the received report from the VUE(s) may further include information on the GNSS timing. This timing information may be used by apparatus 10 to optimize the scheduling within a shared carrier. In one embodiment, apparatus 10 may be controlled to calculate the timing difference between its own clock and GNSS or GNSS-equivalent based on the timing reported by GNSS timing reported by the VUE(s) and the corresponding timing advance (TA) value. In another embodiment, the received report from the VUE(s) may further include T_{d} or TA/2−T_{d} (the difference between cellular timing and GNSS timing as illustrated in FIG. 4). According to one embodiment, a trigger for in coverage VUEs to report T_{d} or TA/2−T_{d} may include: first time detecting OOC VUE, the previous value is no longer valid, and/or it is requested by apparatus 10. In other embodiments, the VUE(s) may report T_{d} or TA/2−T_{d} periodically. In other words, the VUE(s) may report the information of the timing difference between GNSS and the cellular timing. The VUE(s) may also report the information of the timing difference between GNSS and the cellular timing with propagation delay taken into account. The value of the propagation delay may be based on timing advance value. In both cases, the GNSS timing may be GNSS equivalent timing, and the cellular timing may be the timing at the eNB.

In one embodiment, when apparatus 10 receives knowledge of the presence of OOC VUEs, apparatus 10 may be controlled to request in-coverage VUEs to deliver the resource usage recommendation information to OOC VUEs. For example, in an embodiment, apparatus 10 may be controlled to recommend the OOC VUEs to use a certain portion of the pre-configured resources, and the remaining portion of the pre-configured resources may be used by in-coverage VUEs for V2V or cellular communication.

FIG. 5b illustrates an example of an apparatus 20 according to another embodiment. In an embodiment, apparatus 20 may be a node or element in a communications network or associated with such a network, such as a UE, vehicular UE (VUE), a machine type UE, NB-IoT UE, or other device. For instance, in some embodiments, apparatus 20 may be an OOC VUE. It should be noted that one of ordinary skill in the art would understand that apparatus 20 may include components or features not explicitly shown in FIG. 5b.

As illustrated in FIG. 5b, apparatus 20 includes a processor 32 for processing information and executing instructions or operations. Processor 32 may be any type of general or specific purpose processor. While a single processor 32 is shown in FIG. 5b, multiple processors may be utilized according to other embodiments. In fact, processor 32 may include one or more of general-purpose computers, special purpose computers, microprocessors, digital signal processors (DSPs), field-programmable gate arrays (FPGAs), application-specific integrated circuits (ASICs), and processors based on a multi-core processor architecture, as examples.

Apparatus 20 may further include or be coupled to a memory 34 (internal or external), which may be coupled to processor 32, for storing information and instructions that may be executed by processor 32. Memory 34 may be one or more memories and of any type suitable to the local application environment, and may be implemented using any suitable volatile or nonvolatile data storage technology such as a semiconductor-based memory device, a magnetic memory device and system, an optical memory device and system, fixed memory, and removable memory. For example, memory 34 can be comprised of any combination of random access memory (RAM), read only memory (ROM), static storage such as a magnetic or optical disk, or any other type of non-transitory machine or computer readable media. The instructions stored in memory 34 may include program instructions or computer program code that, when executed by processor 32, enable the apparatus 20 to perform tasks as described herein.

In some embodiments, apparatus 20 may also include or be coupled to one or more antennas 35 for transmitting and receiving signals and/or data to and from apparatus 20. Apparatus 20 may further include a transceiver 38 configured to transmit and receive information. For instance, transceiver 38 may be configured to modulate information on to a carrier waveform for transmission by the antenna(s) 35 and demodulate information received via the antenna(s) 35 for further processing by other elements of apparatus 20. In other embodiments, transceiver 38 may be capable of transmitting and receiving signals or data directly.

Processor 32 may perform functions associated with the operation of apparatus 20 including, without limitation, precoding of antenna gain/phase parameters, encoding and decoding of individual bits forming a communication message, formatting of information, and overall control of the apparatus 20, including processes related to management of communication resources.

In an embodiment, memory 34 stores software modules that provide functionality when executed by processor 32. The modules may include, for example, an operating system that provides operating system functionality for apparatus 20. The memory may also store one or more functional modules, such as an application or program, to provide additional functionality for apparatus 20. The components of apparatus 20 may be implemented in hardware, or as any suitable combination of hardware and software.

As mentioned above, according to one embodiment, apparatus 20 may be a mobile device, such as a VUE in LTE or LTE-A. In one embodiment, apparatus 20 may be an OOC VUE. According to an embodiment, apparatus 20 may be controlled by memory 34 and processor 32 to determine whether in-coverage VUE(s) are detected. When in-coverage VUE(s) are detected, apparatus 20 may be controlled by memory 34 and processor 32 to transmit V2V signal with reduced transmit power and/or increased repetitions. However, when in-coverage VUE(s) are not detected, apparatus 20 may be controlled by memory 34 and processor 32 to transmit V2V signal with normal parameters.

According to embodiments, programs, also called program products or computer programs, including software routines, applets and macros, may be stored in any apparatus-readable data storage medium and they include program instructions to perform particular tasks. A computer program product may comprise one or more computer-executable components which, when the program is run, are configured to carry out embodiments. The one or more computer-executable components may be at least one software code or portions of it. Modifications and configurations required for implementing functionality of an embodiment may be performed as routine(s), which may be implemented as added or updated software routine(s). Software routine(s) may be downloaded into the apparatus.

Software or a computer program code or portions of it may be in a source code form, object code form, or in some intermediate form, and it may be stored in some sort of carrier, distribution medium, or computer readable medium, which may be any entity or device capable of carrying the program. Such carriers include a record medium, computer memory, read-only memory, photoelectrical and/or electrical carrier signal, telecommunications signal, and software distribution package, for example. Depending on the processing power needed, the computer program may be executed in a single electronic digital computer or it may be distributed amongst a number of computers. The computer readable medium or computer readable storage medium may be a non-transitory medium.

In other embodiments, the functionality of any method or apparatus described herein may be performed by hardware, for example through the use of an application specific integrated circuit (ASIC), a programmable gate array (PGA), a field programmable gate array (FPGA), or any other combination of hardware and software. In yet another embodiment, the functionality may be implemented as a signal, a non-tangible means that may be carried by an electromagnetic signal downloaded from the Internet or other network.

According to an embodiment, an apparatus, such as a node, device, or a corresponding component, may be configured as a computer or a microprocessor, such as single-chip computer element, or as a chipset, including at least a memory for providing storage capacity used for arithmetic operation and an operation processor for executing the arithmetic operation.

In view of the above, embodiments of the invention provide several advantages and result in significant technical improvements to communications networks and radio systems. As discussed in detail above, embodiments provide methods to reduce interference from OOC VUEs to cellular operation. In addition, embodiments have minimal, if any, negative impact on the eNB.

One embodiment is directed to a method including configuring, by an eNB, one or more VUE(s) at cell/coverage edge to detect OOC VUE(s). The method may also include receiving a report, from the configured VUE(s), including information on whether any OOC VUE(s) are detected. The method may then include optimizing resource scheduling by taking into account possible interference from any detected OOC VUE(s).

In one embodiment, the configuring of VUE(s) may include requesting that a VUE having RSRP that is less than a predefined threshold to report detected OOC VUE(s). According to an embodiment, when a configured VUE reports that no OOC VUE(s) are detected, the optimizing may include scheduling the configured VUE on a radio resource shared by cellular and V2V communications. In another embodiment, when a configured VUE reports that OOC VUE(s) are detected, the optimizing may include scheduling the configured VUE on a radio resource that is not shared with V2V communications.

According to an embodiment, the report received from the VUE(s) may also include information on GNSS timing, and the GNSS timing may be used in the optimizing of resource scheduling. In an embodiment, the report received from the VUE(s) may also include information of the timing difference between GNSS and the cellular timing The report received from the VUE(s) may also include the information of the timing difference between GNSS and the cellular timing with propagation delay taken into account. For example, the report may include T_{d} or TA/2−T_{d}, where T_{d} is the time difference between GNSS and eNB timing at the VUE(s). The value of the propagation delay may be based on timing advance (TA) value. In both cases, the GNSS timing may be GNSS equivalent timing, and the cellular timing may be the timing at the eNB.

In one embodiment, the method may also include calculating timing difference between the eNB clock, or the cellular timing, and GNSS based on the GNSS timing reported by the VUE(s) and the corresponding timing advance (TA) value. For example, the method may include calculating the timing difference between the eNB clock and GNSS based timing, for example, according to the following equation: Tₚ−T_{d}=TA/2−T_{d}, where Tₚ is the propagation delay.

According to one embodiment, a trigger for the VUEs to report T_{d} or TA/2−T_{d} may include: first time detecting OOC VUE, the previous value is no longer valid, and/or it is requested by the eNB. In other embodiments, the VUE(s) may report T_{d} or TA/2−T_{d} periodically or aperiodically.

Another embodiment is directed to an apparatus that includes at least one processor, and at least one memory including computer program code. The at least one memory and the computer program code may be configured, with the at least one processor, to configure one or more VUE(s) at cell edge to detect and/or report OOC VUE(s), to receive a report, from the configured VUE(s), including information on whether any OOC VUE(s) are detected. The at least one memory and the computer program code may be further configured, with the at least one processor, to optimize resource scheduling by taking into account possible interference from any detected OOC VUE(s).

In one embodiment, the at least one memory and the computer program code may be further configured, with the at least one processor, to request that a VUE having RSRP that is less than a predefined threshold to report detected OOC VUE(s). According to an embodiment, when a configured VUE reports that no OOC VUE(s) are detected, the at least one memory and the computer program code may be further configured, with the at least one processor, to optimize scheduling by scheduling the configured VUE on a radio resource shared by cellular and V2V communications. In another embodiment, when a configured VUE reports that OOC VUE(s) are detected, the at least one memory and the computer program code may be further configured, with the at least one processor, to optimize scheduling by scheduling the configured VUE on a radio resource that is not shared with V2V communications.

According to an embodiment, the report received from the VUE(s) may also include information on GNSS timing, and the GNSS timing may be used in the optimizing of resource scheduling. In an embodiment, the report received from the VUE(s) may also include information of the timing difference between GNSS and the cellular timing. The report received from the VUE(s) may also include the information of the timing difference between GNSS and the cellular timing with propagation delay taken into account. For example, the report may include T_{d} or TA/2−T_{d}, where T_{d} is the time difference between GNSS and eNB timing at the VUE(s). The value of the propagation delay may be based on timing advance (TA) value. In both cases, the GNSS timing may be GNSS equivalent timing, and the cellular timing may be the timing at the eNB.

In one embodiment, the at least one memory and the computer program code may be further configured, with the at least one processor, to calculate timing difference between the eNB clock, or the cellular timing, and GNSS based on the GNSS timing reported by the VUE(s) and the corresponding timing advance (TA) value. For example, the timing difference between the eNB clock and GNSS based timing may be calculated, for example, according to the following equation: Tₚ−T_{d}=TA/2−T_{d}, where Tₚ is the propagation delay.

According to one embodiment, a trigger for the VUE(s) to report T_{d} or TA/2−T_{d} may include: first time detecting OOC VUE, the previous value is no longer valid, and/or it is requested by the apparatus. In other embodiments, the VUE(s) may report T_{d} or TA/2−T_{d} periodically or aperiodically.

Another embodiment is directed to an apparatus that includes configuring means for configuring one or more VUE(s) at cell edge to detect OOC VUE(s). The apparatus may also include receiving means for receiving a report, from the configured VUE(s), including information on whether any OOC VUE(s) are detected. The apparatus may also include optimizing means for optimizing resource scheduling by taking into account possible interference from any detected OOC VUE(s).

In one embodiment, the configuring means may include means for requesting that a VUE having RSRP that is less than a predefined threshold to report detected OOC VUE(s). According to an embodiment, when a configured VUE reports that no OOC VUE(s) are detected, the optimizing means may include means for scheduling the configured VUE on a radio resource shared by cellular and V2V communications. In another embodiment, when a configured VUE reports that OOC VUE(s) are detected, the optimizing means may include means for scheduling the configured VUE on a radio resource that is not shared with V2V communications.

According to an embodiment, the report received from the VUE(s) may also include information on GNSS timing, and the GNSS timing may be used in the optimizing of resource scheduling. In an embodiment, the report received from the VUE(s) may also include information of the timing difference between GNSS and the cellular timing. The report received from the VUE(s) may also include the information of the timing difference between GNSS and the cellular timing with propagation delay taken into account. For example, the report may include T_{d} or TA/2−T_{d}, where T_{d} is the time difference between GNSS and eNB timing at the VUE(s). The value of the propagation delay may be based on timing advance (TA) value. In both cases, the GNSS timing may be GNSS equivalent timing, and the cellular timing may be the timing at the eNB.

In one embodiment, the apparatus may include calculating means for calculating timing difference between the eNB clock, or the cellular timing, and GNSS based on the GNSS timing reported by the VUE(s) and the corresponding timing advance (TA) value. For example, the timing difference between the eNB clock and GNSS based timing may be calculated, for example, according to the following equation: Tₚ−T_{d}=TA/2−T_{d}, where Tₚ is the propagation delay.

According to one embodiment, a trigger for the VUEs to report T_{d} or TA/2−T_{d} may include: first time detecting OOC VUE, the previous value is no longer valid, and/or it is requested by the apparatus. In other embodiments, the VUE(s) may report T_{d} or TA/2−T_{d} periodically or aperiodically.

Another embodiment is directed to a computer program embodied on a non-transitory computer readable medium. The computer program may be controlled by a processor to perform a process that includes configuring one or more VUE(s) at cell edge to detect OOC VUE(s). The process may also include receiving a report, from the configured VUE(s), including information on whether any OOC VUE(s) are detected. The process may then include optimizing resource scheduling by taking into account possible interference from any detected OOC VUE(s).

In one embodiment, the configuring of VUE(s) may include requesting that a VUE having RSRP that is less than a predefined threshold to report detected OOC VUE(s). According to an embodiment, when a configured VUE reports that no OOC VUE(s) are detected, the optimizing may include scheduling the configured VUE on a radio resource shared by cellular and V2V communications. In another embodiment, when a configured VUE reports that OOC VUE(s) are detected, the optimizing may include scheduling the configured VUE on a radio resource that is not shared with V2V communications.

According to an embodiment, the report received from the VUE(s) may also include information on GNSS timing, and the GNSS timing may be used in the optimizing of resource scheduling. In an embodiment, the report received from the VUE(s) may also include information of the timing difference between GNSS and the cellular timing. The report received from the VUE(s) may also include the information of the timing difference between GNSS and the cellular timing with propagation delay taken into account. For example, the report may include T_{d} or TA/2−T_{d}, where T_{d} is the time difference between GNSS and eNB timing at the VUE(s). The value of the propagation delay may be based on timing advance (TA) value. In both cases, the GNSS timing may be GNSS equivalent timing, and the cellular timing may be the timing at the eNB.

In one embodiment, the process may further include calculating timing difference between the eNB clock, or the cellular timing, and GNSS based on the GNSS timing reported by the VUE(s) and the corresponding timing advance (TA) value. For example, the timing difference between the eNB clock and GNSS based timing may be calculated, for example, according to the following equation: Tₚ−T_{d}=TA/2−T_{d}, where Tₚ is the propagation delay.

According to one embodiment, a trigger for the VUEs to report T_{d} or TA/2−T_{d} may include: first time detecting OOC VUE, the previous value is no longer valid, and/or it is requested by the eNB. In other embodiments, the VUE(s) may report T_{d} or TA/2−T_{d} periodically or aperiodically.

Another embodiment is directed to a method including determining whether in-coverage VUE(s) are detected. When in-coverage VUE(s) are detected, the method may include transmitting V2V signal with reduced transmit power, increased repetitions of transmission, and/or more robust modulation and coding scheme. When in-coverage VUE(s) are not detected, the method may include transmitting V2V signal with normal parameters. In an embodiment, the method may further include receiving network timing information, from in-coverage VUE(s), indicating whether to use GNSS timing, to use cellular timing, or to synchronize to timing indicated by the in-coverage VUE(s).

Another embodiment is directed to an apparatus that includes at least one processor, and at least one memory including computer program code. The at least one memory and the computer program code may be configured, with the at least one processor, to determine whether in-coverage VUE(s) are detected. When in-coverage VUE(s) are detected, the at least one memory and the computer program code may be configured, with the at least one processor, to transmit V2V signal with reduced transmit power, increased repetitions of transmissions, and/or more robust modulation and coding scheme. When in-coverage VUE(s) are not detected, the at least one memory and the computer program code may be configured, with the at least one processor, to transmit V2V signal with normal parameters. In an embodiment, the at least one memory and the computer program code may be configured, with the at least one processor, to receive network timing information, from in-coverage VUE(s), indicating whether to use GNSS timing, to use cellular timing, or to synchronize to timing indicated by the in-coverage VUE(s).

Another embodiment is directed to an apparatus including determining means for determining whether in-coverage VUE(s) are detected. When in-coverage VUE(s) are detected, the apparatus may include transmitting means for transmitting V2V signal with reduced transmit power, increased repetitions of transmission, and/or more robust modulation and coding scheme. When in-coverage VUE(s) are not detected, the apparatus may include transmitting means for transmitting V2V signal with normal parameters. In an embodiment, the apparatus may further include receiving means for receiving network timing information, from in-coverage VUE(s), indicating whether to use GNSS timing, to use cellular timing, or to synchronize to timing indicated by the in-coverage VUE(s).

Another embodiment is directed to a computer program embodied on a non-transitory computer readable medium. The computer program may be controlled by a processor to perform a process that includes determining whether in-coverage VUE(s) are detected. When in-coverage VUE(s) are detected, the process may include transmitting V2V signal with reduced transmit power, increased repetitions of transmissions, and/or more robust modulation and coding scheme. When in-coverage VUE(s) are not detected, the process may include transmitting V2V signal with normal parameters. In an embodiment, the process may further include receiving network timing information, from in-coverage VUE(s), indicating whether to use GNSS timing, to use cellular timing, or to synchronize to timing indicated by the in-coverage VUE(s).

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

1-26. (canceled)

27. An apparatus, comprising:
at least one processor; and
at least one memory including computer program code;
the at least one memory and the computer program code are configured, with the at least one processor, to cause the apparatus at least to
receive timing information from a user equipment; and
determine a timing difference between network timing at the apparatus and at least one of global navigation satellite system (GNSS) timing at the apparatus or the received timing information,
wherein the received timing information comprises at least one of a global navigation satellite system (GNSS) timing at the user equipment or a timing difference calculated based on a network timing at the user equipment and the global navigation satellite system (GNSS) timing at the user equipment.

28. The apparatus according to claim 27, wherein a timing advance (TA) value of the user equipment is included in the received timing information.

29. The apparatus according to claim 27, wherein the user equipment comprises at least one in-coverage vehicle user equipment, and wherein the apparatus comprises an evolved node B (eNB).

30. The apparatus according to claim 27, wherein the at least one memory and the computer program code are further configured, with the at least one processor, to cause the apparatus at least to calculate the timing difference between the network timing at the apparatus and the global navigation satellite system (GNSS) timing based on at least one of the timing information received from the user equipment and timing advance (TA) commands issued by the apparatus.

31. The apparatus according to claim 27, wherein the user equipment is triggered to report the timing information to the apparatus when at least one of the following occurs: a first time detecting an out of coverage vehicle user equipment, a previous value of the timing information is no longer valid, or a request is made by the base station.

32. An apparatus, comprising:
at least one processor; and
at least one memory including computer program code;
the at least one memory and the computer program code are configured, with the at least one processor, to cause the apparatus at least to
receive timing information from a network node; and
forward the timing information to an out of coverage vehicle user equipment.

33. The apparatus according to claim 32, wherein the timing information indicates whether the out of coverage vehicle user equipment utilizes global navigation satellite system (GNSS) timing or synchronize to timing indicated by an in-coverage vehicle user equipment.

34. An apparatus, comprising:
at least one processor; and
at least one memory including computer program code;
the at least one memory and the computer program code are configured, with the at least one processor, to cause the apparatus at least to
send timing information to a base station,
wherein the timing information comprises at least one of a global navigation satellite system (GNSS) timing at the apparatus or a timing difference calculated based on a network timing at the apparatus and the global navigation satellite system (GNSS) timing at the apparatus.

35. The apparatus according to claim 34, wherein the at least one memory and the computer program code are configured, with the at least one processor, to cause the apparatus at least to include a timing advance (TA) value of the apparatus in the timing information sent to the base station.

36. The apparatus according to claim 34, wherein the apparatus comprises at least one in-coverage vehicle user equipment, and wherein the base station comprises an evolved node B (eNB).

37. The apparatus according to claim 34, wherein the at least one memory and the computer program code are configured, with the at least one processor, to cause the apparatus at least to trigger thee report of the timing information to the base station when at least one of the following occurs: a first time detecting an out of coverage vehicle user equipment, a previous value of the timing information is no longer valid, or a request is made by the base station.
